(19) United States
(12) Patent Application Publication
(10) Pub. No.: US 2007/0074433 A1
(43) Pub. Date: Apr. 5, 2007

(54) System and method for controlling outdoor signs

(75) Inventors: Charles Lee Lindsay, Monument, CO (US); Vance Franklin Brown, Colorado Springs, CO (US); Gene Gary Daigle, Woodland Park, CO (US); Mike Alan Rose, Divide, CO (US)

Correspondence Address: LAW OFFICE OF DALE B. HALLING, LLC, 655 SOUTHPOINTE CT, SUITE 100, COLORADO SPRINGS, CO, 80906, US

(73) Assignee: Skyline Products, Inc.

(21) Appl. No.: 11/250,273

(22) Filed: Oct. 14, 2005

(51) Int. Cl. G09F 13/04

(52) U.S. Cl. 40/574; 705/400

(57) ABSTRACT

A system for controlling outdoor signs has an outdoor sign having a price that is controllable. A controller sends a price signal that controls the price on the outdoor sign. A feedback system determines if the outdoor sign is functioning properly.

### RELATED APPLICATIONS

None

### FIELD OF THE INVENTION

The present invention relates generally to the field of outdoor signs and more particularly to a system and method for controlling outdoor signs.

### BACKGROUND OF THE INVENTION

Retail gas stations have large outdoor signs that display the price they are charging for various grades of gasoline. These signs have to be changed often because of the volatility of gas prices. When the weather is bad it is often difficult for employees to get outside and change the signs.

Most retail gas outlets make only a few cents per gallon of gasoline, however if the price of a store's gasoline is out of line with local competitors prices, they will not have as many customers enter the store and buy the high margin items. As a result, retail gas stores need to know what their competitors are charging for gasoline as well as other price factors, such as the weather, spot price of crude, etc. to properly set their price. While all this data is important it may overwhelm the retail gas station owner. As a result, it is also important to have a system for digesting the price factor data and providing a price or range of prices. There are some systems that provide price data and other systems that provide systems to analyze the data and set the price. There are also controllable price signs. However, there are no systems that combine all these needed features together.

Thus there exists a need for a system that collects price data, analyzes the price data to determine an optimal price, implement a price change at the store and updates a price sign.

### SUMMARY OF INVENTION

A system that overcomes these and other problems has an outdoor sign having a price that is controllable. A controller sends a price signal that controls the price on the outdoor sign. A feedback system determines if the outdoor sign is functioning properly. A server stores competitive prices in electronic form and is in communication with the controller. The server may have a price rule algorithm based on the competitive prices. The server may transmit an alert message to a portable wireless device. The controller may communicate with a point of sale system to change the price. The point of sale system may communicate with a sign interface system. The server may receive the competitive prices from a number of price sources.

In one embodiment, a method of operating a system for controlling outdoor signs includes the steps of determining a price based on a price algorithm. An alert signal including the price is transmitted. A displayed price on a controllable outdoor sign is remotely changed. A displayed price may be checked electronically. The price changes can be verified. When the displayed price contains an error, an error message is transmitted. Competing prices may be gathered as part of the process of determining a price as well as other price factors. The alert signal may be transmitted to a cellular telephone. The suggested price may be input into a point of sale system.

In one embodiment, a system for controlling outdoor signs includes a server coupled to a number of price factor data sources. A controller is in communication with the server. A controllable sign receives a display price signal from the controller and has a feedback system that determines if the display price is operative. The server may have a price algorithm. The server may be coupled to an alerting system. The alerting system may include a cellular telephone network. The controller may communicate with a point of sale system. A sign interface system may be coupled to the point of sale system.

### BRIEF DESCRIPTION OF THE DRAWINGS

FIG. 1 is a block diagram of a system for controlling outdoor signs in accordance with one embodiment of the invention; and

FIG. 2 is a flow chart of the steps in a method of operating a system for controlling outdoor signs in accordance with one embodiment of the invention.

### DETAILED DESCRIPTION OF THE DRAWINGS

The present invention is directed to solving the need for an outdoor sign system that collects competitive data, analyzes the data to determine an optimal price, deploying a price change to individual stores automatically and in plurality, and updating a price sign at a retail outlet. The system collects data from both commercially available sources and from the store manager. The server that collects the data has a number of pricing algorithms. The store owner can select a specific algorithm or create his own pricing algorithm. The server then notifies the store or the owner when a price change should be implemented based on the specific pricing algorithm. The price may then be changed by using a controller to change the display price on the outdoor sign. In one embodiment, the controller is tied to the server and automatically changes the display price. This system allows the gasoline retail store owner to maximize his sales and increase his store traffic for higher margin items. This system provides centralized control for the multi-store company saving time and money.

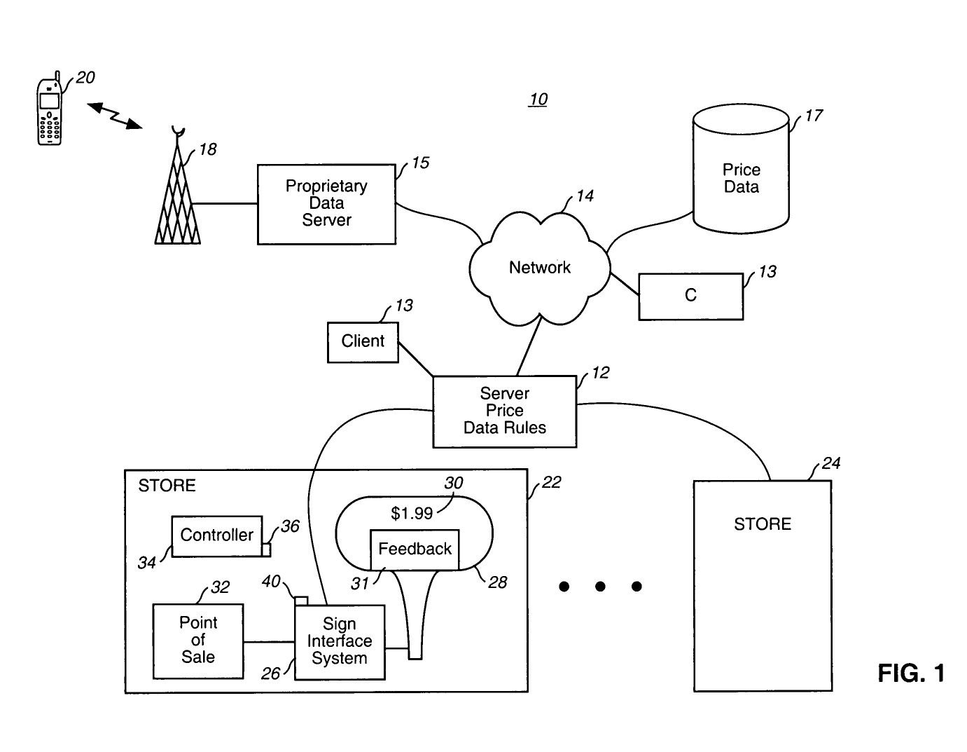

FIG. 1 is a block diagram of a system 10 for controlling outdoor signs in accordance with one embodiment of the invention. The system 10 has a store server 12 that stores competitive price data and has price rules and algorithms. The store server 12 may be connected to one or more clients 13, either directly or over a network 14. The store server 12 is connected through a network 14 to a proprietary data server 15. The proprietary server 15 is connected to one or more commercial price data services 17 through the network 14. The network 14 may be the internet but may be any other communication network. The proprietary server 15 is coupled to a wireless or conventional network 18 which couples the server 15 to a cellular telephone 20 or other wireless communication device.

The store server 12 is coupled to a plurality of stores 22, 24. Note that the store server 12 may not be located in a store. In one embodiment, the server 12 may connect to the stores 22, 24 through the network 14. Each store has a sign interface system 26 coupled to a controllable sign 28. Note that the controllable sign 28 has a controllable display price 30 that is an electronic display. The controllable sign 28 has a feedback system 31. The sign interface system 26 is coupled to a point of sale system 32. A handheld controller 34 has an interface 36 that allows it to coupled to an interface 40 on the sign interface system 26. The interface 36 may be a physical connection or it may be wireless connection. In addition, the handheld controller may be replaced with a touch-screen display that is coupled to the sign interface system 26. In one embodiment, no handheld or touch screen may be necessary. The store 24 is setup similarly to store 22. Note that it is possible to combine the controller 34 with the point of sale system 32 and it is possible to combine the sign interface system 26 either with the sign 28 or controller 34 or the point of sale system 32.

The operation of the system 10 will be explained with respect to a retail gas company that has multiple retail outlets. As explained above, most of the profits of a retail gas company are made when customers buy the high margin items in the store. The gasoline is mainly used to induce customers to visit the store. If the company prices their gasoline too high then fewer customers stop to get gas and purchase the high margin items in the store. On the other hand the store cannot afford to price the gasoline so low that they are losing money on the sale of gasoline. As a result, it is important for the retail gas company to know the price competitors are charging for gasoline. One method of collecting this data is from commercial gasoline price databases shown as element 17. There are a number of such services. In addition, the service 17 may include data on other price factors such as the spot price for crude oil, gasoline inventory levels, weather issues that may affect delivery, etc. While these services 17 are helpful, the retail gas company may also need to factor in the price of retail outlets within a short distance of each of their stores. A store employee can collect local competitors' price of gasoline using the handheld controller 34 or equivalent device or cellular telephone 20 or other communication device. The information can then be uploaded to the store server 12 and from there to the proprietary data server 15. Note that there may a separate proprietary server 15 for each retail gas company or the server 15 may be segmented and protected with various encryption and password systems so that a single server 15 may serve multiple retail gas companies. The server 15 may also store fuel price, volume and margin information for stores. This information alternatively may be stored in the store server 12.

Once the retail gas company has the necessary data to determine the price of gasoline they want to charge at each of their stores, then they need to process the data and deploy the necessary price changes to the stores. The server 12 has a number of preprogrammed algorithms for setting the price of gasoline once the appropriate data has been collected. For instance, one simple price rule is our price will be one cent per gallon of gasoline less than the nearest competitor. Note for a multiple store company this means that each store 22, 24 may have a different price. Another preprogrammed algorithm is to set a price of gasoline that is in the average for the surrounding area. The server 12 also has a wizard so that more complex pricing algorithms may be setup by the retail gas company. For instance, the wizard may change the price based on the weather or time of day or may alert the retail gas company's pricing manager if the price is below the company's cost. The wizard will allow the company to set the price based on historical traffic patterns or historical traffic patterns and weather and competitor's prices. The wizard makes it easy for a non-programmer to setup these pricing rules and change them if they are not suiting the retail gas company's needs.

Once the price of gasoline is determined the individual stores 22, 24 need to implement the price change. In one embodiment, the server 12 notifies a retail price manager of the need to change the price. This may be accomplished by sending a message over a wireless network 18 to a portable device 20. The manager may then approve the price change and the new price is sent to the store(s) 22, 24. The price may be sent to the sign interface system 26 that then notifies the store manager via the controller 34 to update the price. The store manager then approves the price and uses the controller to change price at the point of sale system 32. The point of sale system 32 then commands the sign interface system 26 to update the display price 30. The feedback system 31 next determines if the display price 30 is operative. Operative means that the display price 30 is legible and correct. If a problem exists with the display price 30, then this is communicated through the sign interface 26 to the server 12 and an alert message is sent over the wireless network 18 to the wireless phone 20. The alert message is also sent to the controller 34 or point of sale system 32. Having a controllable sign 28 instead of a manual sign is critical to making fast and effective decisions on the price of the gasoline. If the sign is manual the employees may not implement the change on time, they may make a mistake in the display price or the wind or other weather may cause the display price to be incorrect.

The sign interface system 26 allows the different types of point of sale systems 32 to communicate with different controllable signs 28. The feedback system 31 may be located in the sign interface 26. The sign interface system 26 may includes a dial-up or other modem to communicate with the server over the web (Internet) or through the PSTN (Public Switched Telephone Network) or it may communicate with the server 12 wirelessly. In one embodiment, the handheld controller 34 communicates with the server 12 and the information is passed through the interface 36, 40 to the sign interface system 26. The point of sale system 32 is a standard piece of equipment that is used in all retail gas stores. In one embodiment, the server 12 is not connected to the wireless network 18 but the sign interface system 26 is connected to the wireless network 18. Clearly, the goals of the system 10 may be accomplished even if the connections between the components are changed.

In one embodiment, the server 12 sends the new gasoline price to the sign interface system 26 or controller 34 and the display price 30 and the price at the point of sale system 32 are automatically updated. An alert message may be sent to the retail gas company's price manager 20 that the price has been changed. The price change may be overruled by the manager and the price changed using the controller 34.

When the system 10 does not automatically change the price, the server 12 sends a notice containing the suggested price change to the retail price manager 20. The manager may then approve or deny the price change, which is implemented at the store 22, 24 using the controller 34. Clearly, the system 10 is very flexible and allows each retail gas company to tailor the system to meet their needs. The basic functions that the system allows the retail gas company are: 1) gathering pricing factors; 2) analyzing the price factors to determine a price; 3) controllably updating the price sign; 4) feedback that the display price is operative; 5) central control and 6) updating point of sale system and pumps.

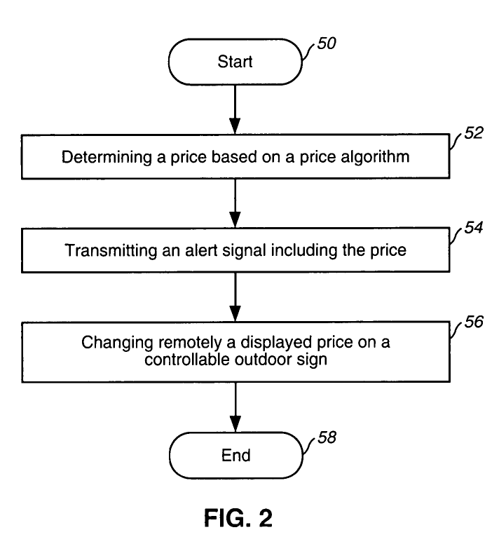

FIG. 2 is a flow chart of the steps in a method of operating a system for controlling outdoor signs in accordance with one embodiment of the invention. The process starts, step 50, by determining a price based on a price algorithm at step 52. An alert signal is transmitted to a manager that includes the price at step 54. At step 56 the display price is changed remotely on the controllable outdoor sign which ends the process at step 58. The step of determining a price includes gather competitive prices and other price factors such as the spot price of oil. The price algorithm system includes a wizard that makes it easy for a user to create price rule that is tailored for the customer. The controllable sign includes a feedback system to determine if the price is legible and displaying the correct price. The feedback system is not just a determination that the price information sent to the sign is correct as in some earlier systems.

Thus there has been described a system and method that collects price data, analyzes the price data to determine an optimal price and updates a price sign. This system provides centralized control for the multi-store company saving time and money.

Note that while the system has been described with respect to retail gas stores, the invention is broader than this specific implementation of the invention. In addition, the sign 30 is shown as a large outdoor sign, the sign may be the pump display.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. A system for controlling outdoor signs, comprising:
an electronic sign having a price that is controllable;
a controller sending a price signal that controls the price on the outdoor sign; and
a feedback system that determines if the outdoor sign is operative.

2. The system of claim 1, further including a store server coupled to the controller and remote from the controller.

3. The system of claim 1, further including a server storing a plurality of competitive prices in electronic communication with the controller.

4. The system of claim 3, wherein the server has a price rule algorithm based on the competitive prices.

5. The system of claim 3, wherein the server can transmit an alert message to a portable wireless device.

6. The system of claim 1, wherein the controller communicates with a point of sale system to change the price.

7. The system of claim 1, wherein the controller includes a point of sale system that changes the price.

8. The system of claim 6, wherein the point of sale system communicates with a sign interface system.

9. The system of claim 3, wherein the server receives the plurality of competitive prices from a plurality of price sources.

10. A method of operating a system for controlling outdoor signs, comprising the steps of:
a) receiving a plurality of competitor prices; and
b) changing remotely a displayed price on a controllable electronic sign.

11. The method of claim 1 0, wherein step (a) further includes the step of:
a1) determining a price based on a price algorithm.

12. The method of claim 10, wherein step (a) further includes the step of:
a1 ) transmitting an alert signal including the price.

13. The method of claim 10, further including the step of:
c) checking a displayed price electronically.

14. The method of claim 13, further including the step of:
d) when the displayed price contains an error, transmitting an error message.

15. The method of claim 10, wherein step (a) further includes the step of:
a1) collecting a plurality of price factors.

16. The method of claim 12, further including the step of:
a2) transmitting the alert signal to a wireless device.

17. The method of claim 10, wherein step (b) further includes the step of:
b1) inputting the price into a point of sale system.

18. A system for controlling outdoor signs, comprising:
a server coupled to a plurality of price factor data sources;
a controller in communication with the server; and
a controllable sign receiving a display price signal from the controller and having a feedback system that determines the display price is operative.

19. The system of claim 18, wherein the server has a price algorithm.

20. The system of claim 19, wherein the server is coupled to an alerting system.

21. The system of claim 20, wherein the alerting system includes a wireless network.

22. The system of claim 18, wherein the controller communicates with a point of sale system.

23. The system of claim 22, further including a sign interface system coupled to the point of sale system.

24. The system of claim 18, wherein the controller is a point of sale system.
